(19) United States
(12) Patent Application Publication
(10) Pub. No.: US 2025/0060734 A1
(43) Pub. Date: Feb. 20, 2025

(54) PROGRAMMABLE LOGIC CONTROLLER, CENTRAL PROCESSING UNIT, AND RECORDING MEDIUM

(71) Applicant: Mitsubishi Electric Corporation, Tokyo (JP)

(72) Inventors: Hiroyuki OZAWA, Tokyo (JP); Yuki HIDAKA, Tokyo (JP); Chiaki KATAOKA, Tokyo (JP)

(73) Assignee: Mitsubishi Electric Corporation, Tokyo (JP)

(21) Appl. No.: 18/724,611

(22) PCT Filed: Mar. 8, 2022
(86) PCT No.: PCT/JP2022/010122

§ 371 Date: Jun. 27, 2024

(51) Int. Cl. G05B 19/418

(52) U.S. Cl. CPC G05B 19/41835; G05B 2219/31001

(57) ABSTRACT

Central processing units can perform factory automation control independently of each other. A first output selector selects to stop or not to stop an operation of a second central processing unit when a voltage drop in an internal power supply in a first central processing unit is detected. A first reset signal output controller stops the operation of the second central processing unit when the first output selector selects to stop the operation of the second central processing unit, and does not stop the operation of the second central processing unit when the first output selector selects not to stop the operation of the second central processing unit.

### TECHNICAL FIELD

The present disclosure relates to a programmable logic controller, a central processing unit (CPU), a control method, and a program.

### BACKGROUND ART

Production sites have used factory automation (FA) in which control devices such as a programmable logic controller (PLC) control devices and facilities in the factory. A control system using such control devices is to promptly respond to an abnormality to reduce a decrease in the production capacity.

Patent Literature 1 describes a control system in which a user uses a support device connected to a PLC to group multiple devices controlled by a CPU of the PLC as appropriate for intended control. In the control system described in Patent Literature 1, the user can use the support device to set the operation of the devices other than the device with an abnormality to stop, fall back, or continue based on the abnormality.

Patent Literature 2 describes a substrate processing apparatus including multiple controllers that control multiple processing blocks and a main controller that controls the multiple controllers. When one of the multiple controllers has a failure in the substrate processing apparatus described in Patent Literature 2, a user can operate the main controller to restart the remaining controllers for fallback.

Patent Literature 3 describes a control system in which multiple controllers that can control an external device are connected to one another for mutual communication, and one controller can instruct another controller to control the external device. In the control system described in Patent Literature 3, a PLC, a motion controller, a numerical controller, and a robot controller are mounted on a base unit, and the PLC serves as a master controller when mounted at a predetermined position.

### CITATION LIST

### Patent Literature

Patent Literature 1: Unexamined Japanese Patent Application Publication No. 2018-200731
Patent Literature 2: Unexamined Japanese Patent Application Publication No. 2015-156105
Patent Literature 3: Japanese Patent No. 4795260

### SUMMARY OF INVENTION

### Technical Problem

When one of the devices has an abnormality in the control system described in Patent Literature 1, the remaining devices can continue operating. However, when the CPU of the PLC has an abnormality, the devices with no abnormality cannot continue operating.

In contrast, when one of the multiple controllers performing control in the substrate processing apparatus described in Patent Literature 2 has an abnormality, the remaining controllers can continue operating. However, the remaining controllers in the substrate processing apparatus described in Patent Literature 2 are restarted to continue operating, after being suspended. Additionally, when the main controller has an abnormality in the substrate processing apparatus described in Patent Literature 2, the controllers with no abnormality cannot continue operating.

When the PLC performing sequence control as the master controller has a failure in the control system described in Patent Literature 3, similarly to the system in Patent Literature 2, the remaining controllers stop, thus stopping the operation of the entire system. More specifically, a power supply monitoring integrated circuit (IC) inside the PLC detects a voltage drop in the internal power supply and outputs a reset signal to the remaining controllers mounted on the base unit. This stops the remaining controllers, in addition to the PLC with a failure. Additionally, the control system described in Patent Literature 3 includes the multiple controllers that control one another. Thus, when a controller other than the PLC has a failure as well, the controller with a failure outputs a reset signal to the remaining controllers, stopping the remaining controllers including the PLC, in addition to the controller with a failure. An abnormality in any of the controllers in the control system described in Patent Literature 3 can stop the remaining controllers.

Under the above circumstances, an objective of the present disclosure is to allow selection between stopping and continuing the entire operation when an abnormality occurs.

### Solution to Problem

To achieve the above objective, a programmable logic controller according to an aspect of the present disclosure includes a first central processing unit and a second central processing unit capable of controlling a control target device independently of each other. The programmable logic controller includes a selector to select to stop or not to stop an operation of the second central processing unit when a voltage drop in an internal power supply in the first central processing unit is detected. The programmable logic controller also includes an operation controller to stop the operation of the second central processing unit when the selector selects to stop the operation of the second central processing unit, and not to stop the operation of the second central processing unit when the selector selects not to stop the operation of the second central processing unit.

### Advantageous Effects of Invention

When a voltage drop in the internal power supply in the first CPU is detected and the selection is to stop the second CPU in the programmable logic controller according to the above aspect of the present disclosure, the first CPU and the second CPU stop operating. This stops the operation of the programmable logic controller. In contrast, the programmable logic controller continues operating when the second CPU has not stopped operating upon detecting a voltage drop in the internal power supply in the first CPU and the selection is not to stop the second CPU. Thus, the programmable logic controller can select between a stop mode in which all the CPUs stop operating to stop the entire operation and a fallback mode in which the CPUs with no abnormality continue operating without suspending the entire operation. This allows the programmable logic controller to select to stop or to continue the entire operation when an abnormality occurs.

### BRIEF DESCRIPTION OF DRAWINGS

FIG. 1 is a block diagram of a programmable logic controller according to Embodiment 1 of the present disclosure;

FIG. 2 is a functional block diagram of the programmable logic controller according to Embodiment 1;

FIG. 3 is a block diagram of a CPU according to Embodiment 1, illustrating the hardware configuration;

FIG. 4 is a diagram of a communication circuit for a reset signal between CPUs according to Embodiment 1;

FIG. 5 is a diagram of the communication circuit for the reset signal between the CPUs according to Embodiment 1;

FIG. 6 is a block diagram of a control system according to Embodiment 2 of the present disclosure;

FIG. 7 is a functional block diagram of the control system according to Embodiment 2;

FIG. 8 is a diagram of a display example of setting information in Embodiment 2; and

FIG. 9 is a flowchart of a first stop selection process in Embodiment 2.

### DESCRIPTION OF EMBODIMENTS

A programmable logic controller, a central processing unit (CPU), a control method, and a program according to one or more embodiments of the present disclosure are described in detail below with reference to the drawings. Like reference signs denote like or corresponding components in the drawings. The programmable logic controller is hereafter referred to as a PLC.

### Embodiment 1

### PLC 1 According to Embodiment 1

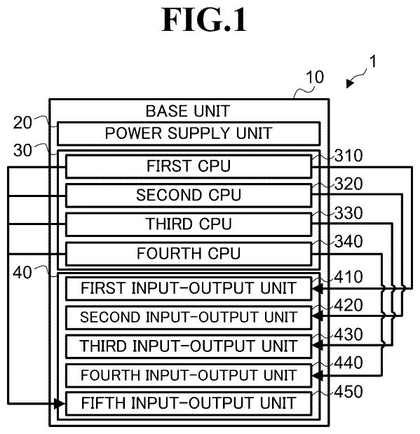

As illustrated in FIG. 1, a PLC 1 according to Embodiment 1 of the present disclosure includes a base unit 10 on which multiple different units are mounted. The PLC 1 also includes a power supply unit 20 that supplies power to each unit through the base unit 10 on which the power supply unit 20 is mounted. The PLC 1 also includes a central processing unit (CPU) 30 that controls factory automation (FA) through the base unit 10 on which the CPU 30 is mounted. The PLC 1 also includes an input-output (I/O) unit 40 that inputs and outputs control signals between the CPU 30 and external devices and between the CPU 30 and external facilities through the base unit 10 on which the I/O unit 40 is mounted.

A recent FA control system is to use new technology such as Internet of things (IoT) or big data to collect and analyze a large amount of data and improve factory productivity.

For example, in addition to known sequence control, the FA control system is to collect, analyze, and use data during operation, such as logs of devices and apparatuses connected through a network and video logs of devices. In particular, the control system is to control the data collection described above to collect and analyze data about multiple operating devices and apparatuses when an abnormality occurs, as well as before and after the abnormality occurs.

Additionally, for example, the globalized market of industrial products has domestically and internationally increased the production at multiple factories located distant from one another. The FA control system is thus to control remote monitoring to check devices and facilities at a production site from a remote office or other remote locations, and to determine, when a trouble occurs, the details of the situation and readily respond to the trouble.

For example, another system different from the control system is typically used in safety control for protecting people, property, and the environment. The other system has operability different from the operability of the control system, and the programs of the two systems are managed separately. This increases the engineering cost in addition to the equipment cost. The FA control system is thus to incorporate the other system in an integrated manner and perform safety control described above to reduce these costs.

Thus, in the PLC 1 used for the FA control system, the CPU 30 performs FA control such as sequence control, data collection control, remote monitoring control, and safety control on external devices and facilities through the I/O unit 40.

### CPU 30 According to Embodiment 1

The CPU 30 includes a first CPU 310, a second CPU 320, a third CPU 330, and a fourth CPU 340. The CPU 30 is a redundant multi-CPU that distributes control to the multiple CPUs 310, 320, 330, and 340. In other words, each of the CPUs 310, 320, 330, and 340 independently performs FA control on the external devices and facilities without serving as a main controller that controls the entire PLC 1. For example, each of the CPUs 310, 320, 330, and 340 independently and separately performs one of sequence control, data collection control, remote monitoring control, and safety control described above, without controlling the entire PLC 1.

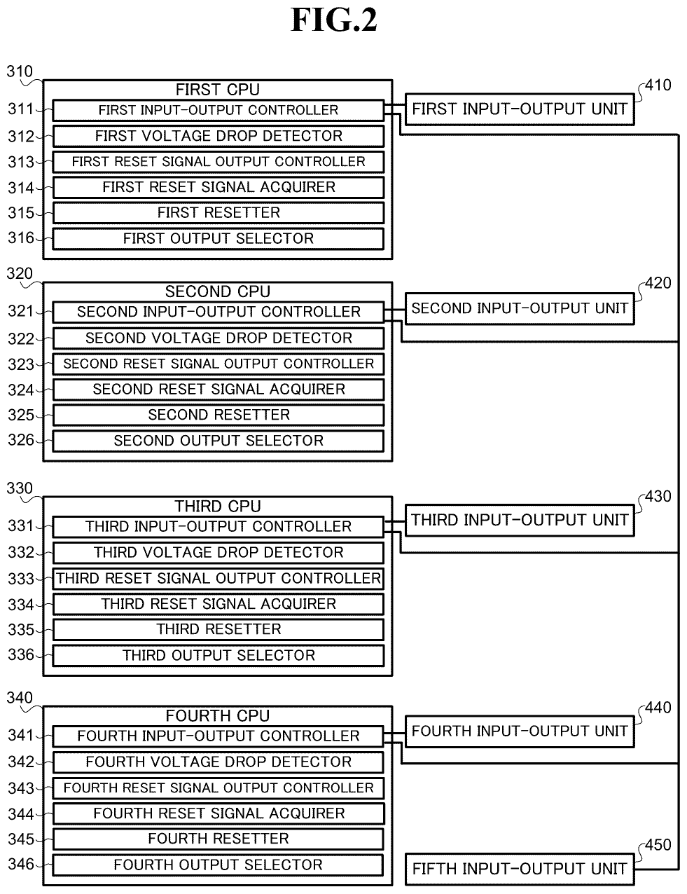

The first CPU 310 performs, for example, sequence control. As illustrated in FIG. 2, the first CPU 310 includes a first input-output controller 311 as an example input-output controller that controls input and output of control signals into and from the I/O unit 40. The first CPU 310 also includes a first voltage drop detector 312 as an example voltage drop detector that detects a voltage drop in an internal power supply. The first CPU 310 also includes a first reset signal output controller 313 as an example operation controller and an example output controller that control output of a reset signal as an example operation stop signal for stopping the operation of the CPU. The first CPU 310 also includes a first reset signal acquirer 314 as an example acquirer that acquires a reset signal. The first CPU 310 also includes a first resetter 315 as an example operation controller and an example operation stop controller that perform a reset process based on the acquired reset signal. The first CPU 310 also includes a first output selector 316 as an example selector and an example output selector that select to output or not to output the reset signal to the other CPUs 320, 330, and 340.

The second CPU 320 controls, for example, data collection. The second CPU 320 includes a second input-output controller 321 as an example input-output controller similar to the first input-output controller 311. The second CPU 320 includes a second voltage drop detector 322 as an example voltage drop detector similar to the first voltage drop detector 312. The second CPU 320 includes a second reset signal output controller 323 as an example operation controller and an example output controller similar to the first reset signal output controller 313. The second CPU 320 includes a second reset signal acquirer 324 as an example acquirer similar to the first reset signal acquirer 314. The second CPU 320 includes a second resetter 325 as an example operation controller and an example operation stop controller similar to the first resetter 315. The second CPU 320 includes a second output selector 326 as an example selector and an example output selector similar to the first output selector 316.

The third CPU 330 controls, for example, remote monitoring. The third CPU 330 includes a third input-output controller 331, a third voltage drop detector 332, a third reset signal output controller 333, a third reset signal acquirer 334, a third resetter 335, and a third output selector 336, similar to the components 311 to 316 in the CPU 310 and the components 321 to 326 in the CPU 320.

The fourth CPU 340 performs, for example, safety control. The fourth CPU 340 includes a fourth input-output controller 341, a fourth voltage drop detector 342, a fourth reset signal output controller 343, a fourth reset signal acquirer 344, a fourth resetter 345, and a fourth output selector 346, similar to the components 311 to 316 in the in CPU 310, the components 321 to 326 in the CPU 320, and the components 331 to 336 in the CPU 330.

### I/O Unit 40 in Embodiment 1

Referring back to FIG. 1, the I/O unit 40 includes a first input-output unit 410 that inputs and outputs control signals associated with sequence control between the first CPU 310 and the external devices and between the first CPU 310 and the external facilities. The I/O unit 40 also includes a second input-output unit 420 that inputs and outputs control signals associated with data collection control between the second CPU 320 and the external devices and between the second CPU 320 and the external facilities. The I/O unit 40 also includes a third input-output unit 430 that inputs and outputs control signals associated with remote monitoring control between the third CPU 330 and the external devices and between the third CPU 330 and the external facilities. The I/O unit 40 also includes a fourth input-output unit 440 that inputs and outputs control signals associated with safety control between the fourth CPU 340 and the external devices and between the fourth CPU 340 and the external facilities. The I/O unit 40 also includes a fifth input-output unit 450 that inputs and outputs control signals associated with FA control between the CPUs 310, 320, 330, and 340 and the external devices and between the CPUs 310, 320, 330, and 340 and the external facilities.

### Hardware Configuration of CPUs 310, 320, 330, and 340 According to Embodiment 1

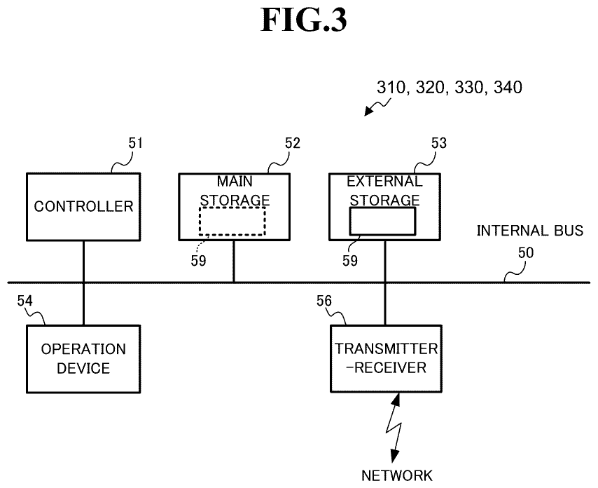

As illustrated in FIG. 3, each of the CPUs 310, 320, 330, and 340 includes a controller 51 that performs processes based on a control program 59. The controller 51 includes a CPU. The controller 51 functions as, based on the control program 59, one of the input-output controllers 311, 321, 331, and 341, one of the voltage drop detectors 312, 322, 332, and 342, and one of the resetters 315, 325, 335, and 345 illustrated in FIG. 2.

Referring back to FIG. 3, each of the CPUs 310, 320, 330, and 340 includes a main storage 52 that loads the control program 59 and is used as a work area for the controller 51. The main storage 52 includes a random-access memory (RAM).

Each of the CPUs 310, 320, 330, and 340 includes an external storage 53 that prestores the control program 59. The external storage 53 provides, as instructed by the controller 51, data stored in the program to the controller 51 and stores data provided from the controller 51. The external storage 53 includes a nonvolatile memory such as a flash memory.

Each of the CPUs 310, 320, 330, and 340 includes an operation device 54 operable by a user. Information input with the operation device 54 is provided to the controller 51. The operation device 54 includes, for example, an information input component such as a switch described later. The operation device 54 functions as one of the output selectors 316, 326, 336, and 346 illustrated in FIG. 2.

Referring back to FIG. 3, each of the CPUs 310, 320, 330, and 340 includes a transmitter-receiver 56 that transmits and receives information. The transmitter-receiver 56 includes an information communication component such as a network termination device or a wireless communication device connected to a network. The transmitter-receiver 56 functions as one of the reset signal output controllers 313, 323, 333, and 343 and one of the reset signal acquirers 314, 324, 334, and 344 illustrated in FIG. 2.

Referring back to FIG. 3, in each of the CPUs 310, 320, 330, and 340, the main storage 52, the external storage 53, the operation device 54, and the transmitter-receiver 56 are connected to the controller 51 with an internal bus 50.

In each of the CPUs 310, 320, 330, and 340, the controller 51 implements the functions of one of the components 311 to 316, one of the components 321 to 326, one of the components 331 to 336, and one of the components 341 to 346 illustrated in FIG. 2, using the main storage 52, the external storage 53, the operation device 54, and the transmitter-receiver 56 as resources.

For example, the first CPU 310 performs a first input-output controller step as an example input-output controller step performed by the first input-output controller 311. The first CPU 310 also performs a first voltage drop detection step as an example voltage drop detection step performed by the first voltage drop detector 312. The first CPU 310 also performs a first reset signal output control step as an example operation control step and an example output control step performed by the first reset signal output controller 313. The first CPU 310 also performs a first reset signal acquisition step as an example acquisition step performed by the first reset signal acquirer 314. The first CPU 310 also performs a first resetting step as an example operation controller and an example operation stop control step performed by the first resetter 315. The first CPU 310 also performs a first output selection step as an example selection step and an example output selection step performed by the first output selector 316.

For example, the second CPU 320 performs a second input-output controller step as an example input-output controller step performed by the second input-output controller 321. The second CPU 320 also performs a second voltage drop detection step as an example voltage drop detection step performed by the second voltage drop detector 322. The second CPU 320 also performs a second reset signal output control step as an example operation control step and an example output control step performed by the second reset signal output controller 323. The second CPU 320 also performs a second reset signal acquisition step as an example acquisition step performed by the second reset signal acquirer 324. The second CPU 320 also performs a second resetting step as an example operation control step and an example operation stop control step performed by the second resetter 325. The second CPU 320 also performs a second output selection step as an example selection step and an example output selection step performed by the second output selector 326.

For example, the third CPU 330 performs a third input-output controller step as an example input-output controller step performed by the third input-output controller 331. The third CPU 330 also performs a third voltage drop detection step as an example voltage drop detection step performed by the third voltage drop detector 332. The third CPU 330 also performs a third reset signal output control step as an example operation control step and an example output control step performed by the third reset signal output controller 333. The third CPU 330 also performs a third reset signal acquisition step as an example acquisition step performed by the third reset signal acquirer 334. The third CPU 330 also performs a third resetting step as an example operation control step and an example operation stop control step performed by the third resetter 335. The third CPU 330 also performs a third output selection step as an example output selection step performed by the third output selector 336.

For example, the fourth CPU 340 performs a fourth input-output controller step as an example input-output controller step performed by the fourth input-output controller 341. The fourth CPU 340 also performs a fourth voltage drop detection step as an example voltage drop detection step performed by the fourth voltage drop detector 342. The fourth CPU 340 also performs a fourth reset signal output control step as an example operation control step and an example output control step performed by the fourth reset signal output controller 343. The fourth CPU 340 also performs a fourth reset signal acquisition step as an example acquisition step performed by the fourth reset signal acquirer 344. The fourth CPU 340 also performs a fourth resetting step as an example operation control step and an example operation stop control step performed by the fourth resetter 345. The fourth CPU 340 also performs a fourth output selection step as an example output selection step performed by the fourth output selector 346.

### Details of Functional Configuration of CPUs 310, 320, 330, and 340 According to Embodiment 1

Referring back to FIG. 2, the first input-output controller 311 controls input and output of control signals into and from the first input-output unit 410 and also controls input and output of control signals into and from the fifth input-output unit 450.

The first reset signal acquirer 314 acquires a reset signal output from the first CPU 310 or one of the other CPUs 320, 330, and 340.

The first resetter 315 performs, when the first reset signal acquirer 314 acquires the reset signal, the reset process and stops the operation of the first CPU 310.

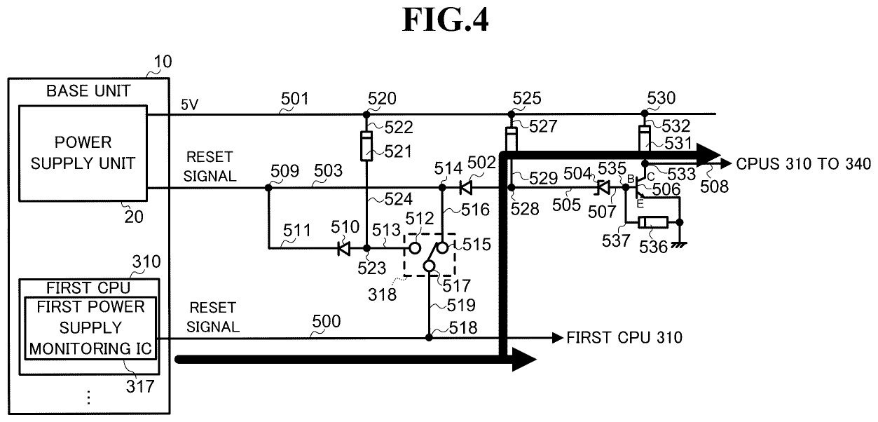

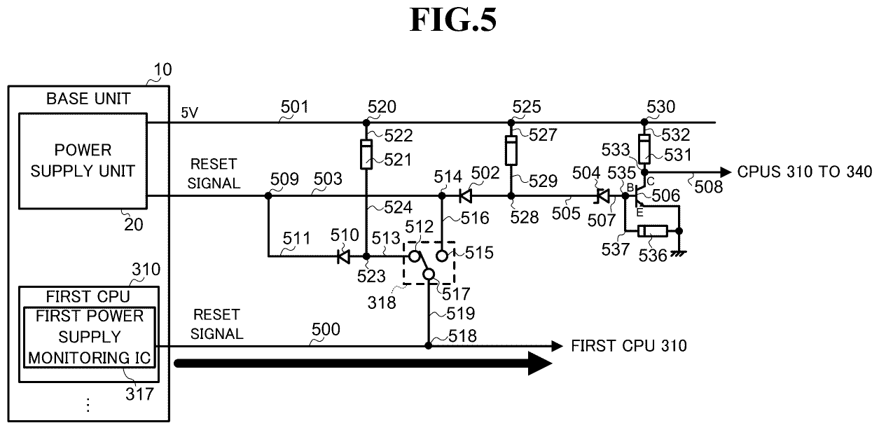

In the power supply unit 20 and each of the CPUs 310, 320, 330, and 340, a reset signal can be transmitted and received through, for example, a circuit illustrated in FIGS. 4 and 5. The functions of the first voltage drop detector 312 and the first reset signal output controller 313 can be implemented by, for example, a first power supply monitoring IC 317 as an example outputter illustrated in FIGS. 4 and 5. The function of the first output selector 316 can be implemented by, for example, a first switch 318 as an example switch illustrated in FIGS. 4 and 5. The first switch 318 is, for example, a single-pole double-throw switch located on the exterior of the first CPU 310 and is operable by the user.

In the circuit illustrated in FIGS. 4 and 5, the power supply unit 20 and each of the CPUs 310, 320, 330, and 340 are connected with a first communication line 501 that has a potential of +5 V. The power supply unit 20 and the cathode of a first diode 502 are connected with a second communication line 503. The anode of the first diode 502 and the cathode of a Zener diode 504 are connected with a third communication line 505. The anode of the Zener diode 504 and the base of a transistor 506 are connected with a fourth communication line 507. The emitter of the transistor 506 is grounded. The collector of the transistor 506 and each of the CPUs 310, 320, 330, and 340 are connected with a fifth communication line 508.

A first contact 509 of the second communication line 503 and the cathode of a second diode 510 are connected with a sixth communication line 511. The anode of the second diode 510 and a first terminal 512 of the first switch 318 are connected with a seventh communication line 513. A second contact 514 of the second communication line 503 and a second terminal 515 of the first switch 318 are connected with an eighth communication line 516. A third terminal 517 of a first circuit switch 318 and a contact 518 of a communication line 500 in an internal circuit of the first CPU 310 are connected with a ninth communication line 519.

A first contact 520 of the first communication line 501 and one end of a first pull-up resistor 521 are connected with a tenth signal line 522. The other end of the first pull-up resistor 521 and a contact 523 of the seventh communication line 513 are connected with an eleventh signal line 524. A second contact 525 of the first communication line 501 and one end of a second pull-up resistor 526 are connected with a twelfth signal line 527. The other end of the second pull-up resistor 526 and a contact 528 of the third communication line 505 are connected with a thirteenth signal line 529. A third contact 530 of the first communication line 501 and one end of a third pull-up resistor 531 are connected with a fourteenth signal line 532. The other end of the third pull-up resistor 531 and a contact 533 of the fifth communication line 508 are connected with a fifteenth signal line 534. A contact 535 of the fourth communication line 507 and one end of a fourth pull-up resistor 536 are connected with a sixteenth signal line 537. The other end of the fourth pull-up resistor 536 is grounded.

Thus, the power supply unit 20 and each of the CPUs 310, 320, 330, and 340 are electrically connected to each other through the components 502 to 508. When the power supply unit 20 has a failure and a voltage drop is detected, the power supply unit 20 outputs a reset signal to each of the CPUs 310, 320, 330, and 340 through the components 502 to 508. More specifically, the potential of the second communication line 503 is changed to change the potential of the base of the transistor 506 being a switching element, causing a current from each of the CPUs 310, 320, 330, and 340 to flow between the collector and the emitter. Each of the CPUs 310, 320, 330, and 340 thus detects the reset signal output from the power supply unit 20 and performs the reset process.

Thus, when the power supply unit 20 has a failure, all the CPUs 310, 320, 330, and 340 stop operating, thus stopping the transmission and reception of control signals into and from all the input-output units 410 to 450.

In the example described below, the first CPU 310 has a failure. In this case, as illustrated by the arrow in FIG. 5, the first power supply monitoring IC 317 detects a voltage drop in the internal power supply in the first CPU 310 and outputs a reset signal to the controller 51 in the first CPU 310 through the communication line 500. Thus, in the first CPU 310 with a failure, the first reset signal acquirer 314 acquires the reset signal, and the first resetter 315 performs the reset process to stop the operation of the first CPU 310.

When the second terminal 515 and the third terminal 517 are connected with the first switch 318, the first switch 318 and the second communication line 503 are connected with the eighth communication line 516 as illustrated in FIG. 4. Thus, when the first power supply monitoring IC 317 outputs the reset signal to the first CPU 310 through the communication line 500, the first power supply monitoring IC 317 also outputs the reset signal to the remaining CPUs 320, 330, and 340 through the respective components 519, 517, 515, 516, and 502 to 508, as illustrated by the arrows in FIG. 4. Each of the CPUs 310, 320, 330, and 340 thus acquires the reset signal and performs the reset process to stop operating, in the same manner as when the power supply unit 20 outputs the reset signal.

Thus, when the second terminal 515 and the third terminal 517 are connected with the first switch 318, all the CPUs 310, 320, 330, and 340, including the first CPU 310 with a failure, stop operating, thus stopping the transmission and reception of control signals into and from all the input-output units 410 to 450.

In contrast, when the first terminal 512 and the third terminal 517 are connected with the first switch 318, the components 510, 524, and 521 are connected to the first power supply monitoring IC 317 between the first switch 318 and the second communication path, as illustrated in FIG. 5. Unlike the circuit illustrated in FIG. 4, when the first power supply monitoring IC 317 outputs the reset signal to the first CPU 310 through the communication line 500, the reset signal is not output to the remaining CPUs 320, 330, and 340, as illustrated by the arrow in FIG. 5. More specifically, the potential of the second communication line 503 is not changed. Thus, the potential of the base of the transistor 506 being a switching element is not changed. The first CPU 310 with a failure performs the reset process, whereas the remaining CPUs 320, 330, and 340 do not perform the reset process.

Thus, when the first terminal 512 and the third terminal 517 are connected with the first switch 318, the first CPU 310 with a failure alone stops operating, whereas the remaining CPUs 320, 330, and 340 can continue operating without suspension. The transmission and reception of control signals is thus stopped between the first CPU 310 with a failure and the first input-output unit 410 alone, whereas the transmission and reception of control signals continues between the remaining CPUs 320, 330, and 340 and the remaining input-output units 420 to 450.

The same processes as above apply to the components 321 to 325 in the second CPU 320, with the first CPU 310 replaced with the second CPU 320, the first input-output controller 311 with the second input-output controller 321, the first voltage drop detector 312 with the second voltage drop detector 322, the first reset signal output controller 313 with the second reset signal output controller 323, the first reset signal acquirer 314 with the second reset signal acquirer 324, the first resetter 315 with the second resetter 325, the first output selector 316 with the second output selector 326, the first power supply monitoring IC 317 with the second power supply monitoring IC 327, the first switch 318 with the second switch 328, the CPUs 320, 330, and 340 with the CPUs 310, 330, and 340, the first input-output unit 410 with the second input-output unit 420, and the input-output units 420 to 450 with the input-output units 410, and 430 to 450. The example with these components is thus not described in detail to avoid redundancy.

The same processes as above apply to the components 331 to 335 in the third CPU 330, with the first CPU 310 replaced with the third CPU 330, the first input-output controller 311 with the third input-output controller 331, the first voltage drop detector 312 with the third voltage drop detector 332, the first reset signal output controller 313 with the third reset signal output controller 333, the first reset signal acquirer 314 with the third reset signal acquirer 334, the first resetter 315 with the third resetter 335, the first output selector 316 with the third output selector 336, the first power supply monitoring IC 317 with the third power supply monitoring IC 337, the first switch 318 with the third switch 338, the CPUs 320, 330, and 340 with the CPUs 310, 320, and 340, the first input-output unit 410 with the third input-output unit 430, and the input-output units 420 to 450 with the input-output units 410, 420, 440 and 450. The example with these components is thus not described in detail to avoid redundancy.

The same processes as above apply to the components 341 to 345 in the fourth CPU 340, with the first CPU 310 replaced with the fourth CPU 340, the first input-output controller 311 with the fourth input-output controller 341, the first voltage drop detector 312 with the fourth voltage drop detector 342, the first reset signal output controller 313 with the fourth reset signal output controller 343, the first reset signal acquirer 314 with the fourth reset signal acquirer 344, the first resetter 315 with the fourth resetter 345, the first output selector 316 with the fourth output selector 346, the first power supply monitoring IC 317 with the fourth power supply monitoring IC 347, the first switch 318 with the fourth switch 348, the CPUs 320, 330, and 340 with the CPUs 310, 320, and 330, the first input-output unit 410 with the fourth input-output unit 440, and the input-output units 420 to 450 with the input-output units 410 to 430 and 450. The example with these components is thus not described in detail to avoid redundancy.

As described above, in the PLC 1 according to the present embodiment, the CPUs 310, 320, 330, and 340 control the input and output of control signals into and from the respective input-output units 410 to 450 with the respective input-output controllers 311, 321, 331, and 341 to perform, independently of each other, FA control associated with the external devices and facilities.

In the first CPU 310, the first voltage drop detector 312 detects a voltage drop in the internal power supply, and the first reset signal output controller 313 outputs a reset signal. The first reset signal acquirer 314 acquires a reset signal output from the CPUs 310, 320, 330, and 340. The first resetter 315 performs the reset process based on the acquired reset signal to stop the operation of the first CPU 310. The first output selector 316 selects to output or not to output the reset signal to the other CPUs 320, 330, and 340 to select to stop or not to stop the operations of the other CPUs 320, 330, and 340

When the first output selector 316 selects to output the reset signal, the first reset signal output controller 313 outputs the reset signal to the other CPUs 320, 330, and 340 to stop the operations of the other CPUs 320, 330, and 340. In contrast, when the first output selector 316 selects not to output the reset signal, the first reset signal output controller 313 does not output the reset signal to the other CPUs 320, 330, and 340 and does not stop the operations of the other CPUs 320, 330, and 340.

The same processes as performed by the components 312 to 316 in the first CPU 310 apply to the components 322 to 326 in the CPU 320, the components 332 to 336 in the CPU 330, and the components 342 to 346 in the CPU 340.

In this manner, the PLC 1 according to the present embodiment stops operating when, for example, the first CPU 310 with an abnormality selects to output the reset signal to the other CPUs 320, 330, and 340. The other CPUs 320, 330, and 340 stop operating. In contrast, the PLC 1 according to the present embodiment continues operating when the first CPU 310 with an abnormality does not select to output the reset signal to the other CPUs 320, 330, and 340. The other CPUs 320, 330, and 340 do not stop operating.

Thus, the PLC 1 according to the present embodiment can perform the above selection in the first CPU 310 with an abnormality to select between a stop mode in which all the CPUs 310, 320, 330, and 340 stop operating to stop the operation of the entire control system and a fallback mode in which the CPUs 320, 330, and 340 with no abnormality continue operating without suspending the operation of the entire control system. This allows the PLC 1 according to the present embodiment to select to stop or to continue the operation of the entire control system when an abnormality occurs.

In the PLC 1 according to the present embodiment, the first output selector 316 can select to output or not to output a reset signal to the other CPUs 320, 330, and 340 based on the output from the first switch 318 illustrated in FIGS. 4 and 5. The first switch 318 is located on the exterior of the first CPU 310 and is operable by the user. The same processes as performed by the first output selector 316 and the first switch 318 in the first CPU 310 apply to the output selector 326 and the switch 328 in the CPU 320, the output selector 336 and the switch 338 in the CPU 330, and the output selector 346 and the switch 348 in the CPU 340.

In this manner, the user can operate each of the switches 318, 328, 338, and 348 to preselect to operate or not to operate the respective CPUs 310, 320, 330, and 340 in the stop mode or in the fallback mode before an abnormality occurs.

For a redundant multi-CPU such as the PLC 1, some users are to continue the entire operation without suspension when any of the CPUs has an abnormality, and to collect data before, during, and after the abnormality. In this case, the PLC is to allow replacement or repair of the CPU with an abnormality during operation, or more specifically, online.

However, a known PLC for FA typically stops the entire operation for safe recovery work when any CPU has a failure, similarly to Patent Literatures 1 to 3 described above. The known PLC thus cannot respond to the user requests described above.

In contrast, the PLC 1 according to the present embodiment can select the fallback mode as described above to allow replacement or repair of the CPU with an abnormality online and to continuously collect data before, during, and after the abnormality. Thus, the PLC 1 according to the present embodiment can respond to the user requests described above.

### Embodiment 2

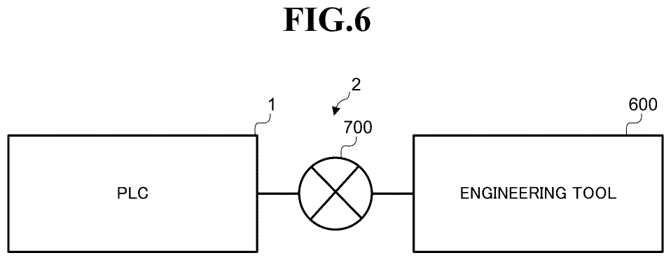

In the PLC 1 according to Embodiment 1, any of the CPUs 310, 320, 330, and 340 with an abnormality selects to output or not to output a reset signal to the remaining CPUs 310, 320, 330, and 340 to select to stop or to continue the entire operation, but the PLC may have another structure. For example, each of the CPUs 310, 320, 330, and 340 may periodically check the operations of the other CPUs and select, when the operation of any of the other CPUs cannot be determined, to stop or not to stop operating to allow the selection to stop or to continue the entire operation. A control system 2 according to Embodiment 2 is described in detail below with reference to FIGS. 6 to 9. In Embodiment 2, components different from those in Embodiment 1 are described, and the same components as in Embodiment 1 are not described to avoid redundancy.

### Control System 2 According to Embodiment 2

As illustrated in FIG. 6, a control system 2 according to Embodiment 2 of the present disclosure includes the PLC 1 and an engineering tool 600. The PLC 1 and the engineering tool 600 are connected through an Internet 700 as an example network.

### CPU 30 According to Embodiment 2

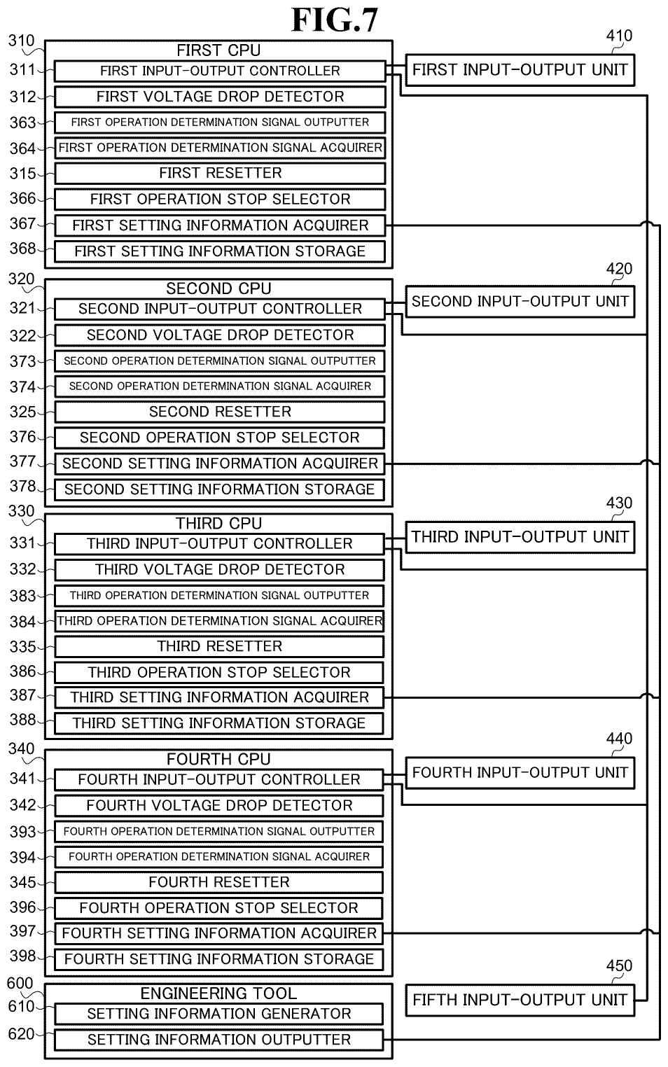

The first CPU 310 includes, in place of the first reset signal output controller 313 illustrated in FIG. 2, a first operation determination signal outputter 363 illustrated in FIG. 7 as an example outputter that outputs an operation determination signal indicating the first CPU 310 being in operation. The first CPU 310 also includes, in place of the first reset signal acquirer 314 illustrated in FIG. 2, a first operation determination signal acquirer 364 illustrated in FIG. 7 as an example acquirer that acquires an operation determination signal from each of the other CPUs 320, 330, and 340. The first CPU 310 also includes, in place of the first output selector 316 illustrated in FIG. 2, a first operation stop selector 366 illustrated in FIG. 7 as an example selector and an example operation stop selector that select to stop or not to stop the operation of the first CPU 310. As illustrated in FIG. 7, the first CPU 310 also includes a first setting information acquirer 367 as an example setting information acquirer and a first setting information storage 368 as an example setting information storage that stores setting information.

The second CPU 320 includes, in place of the second reset signal output controller 323 illustrated in FIG. 2, a second operation determination signal outputter 373 illustrated in FIG. 7 as an example outputter similar to the first operation determination signal outputter 363. The second CPU 320 includes, in place of the second reset signal acquirer 324 illustrated in FIG. 2, a second operation determination signal acquirer 374 illustrated in FIG. 7 as an example acquirer similar to the first operation determination signal acquirer 364. The second CPU 320 includes, in place of the second output selector 326 illustrated in FIG. 2, a second operation stop selector 376 illustrated in FIG. 7 as an example selector and an example operation stop selector similar to the first operation stop selector 366. The second CPU 320 includes, as illustrated in FIG. 7, a second setting information acquirer 377 as an example setting information acquirer similar to the first setting information acquirer 367. The second CPU 320 includes a second setting information storage 378 as an example setting information storage similar to the first setting information storage 368.

The third CPU 330 includes, in place of the third reset signal output controller 333, the third reset signal acquirer 334, and the third output selector 336 illustrated in FIG. 2, a third operation determination signal outputter 383, a third operation determination signal acquirer 384, and a third operation stop selector 386 similar to the respective components 363, 364, 366, 373, 374, and 376 illustrated in FIG. 7. The third CPU 330 also includes a third setting information acquirer 387 and a third setting information storage 388 similar to the respective components 367, 368, 377, and 378 illustrated in FIG. 7.

The fourth CPU 340 includes, in place of the fourth reset signal output controller 343, the fourth reset signal acquirer 344, and the fourth output selector 346 illustrated in FIG. 2, a fourth operation determination signal outputter 393, a fourth operation determination signal acquirer 394, and a fourth operation stop selector 396 similar to the respective components 363, 364, 366, 373, 374, 376, 383, 384, and 386 illustrated in FIG. 7. The fourth CPU 340 also includes a fourth setting information acquirer 397 and a fourth setting information storage 398 similar to the respective components 367, 368, 377, 378, 387, and 388 illustrated in FIG. 7.

### Engineering Tool 600 in Embodiment 2

The engineering tool 600 is, for example, a personal computer on which software for the engineering tool is installed. The engineering tool 600 includes a setting information generator 610 that generates the setting information and a setting information outputter 620 that outputs the setting information.

### Hardware Configuration of CPUs 310, 320, 330, and 340 According to Embodiment 2

Referring back to FIG. 3, in each of the CPUs 310, 320, 330, and 340 according to Embodiment 2, the controller 51 functions as one of the operation stop selectors 366, 376, 386, and 396 illustrated in FIG. 7. The transmitter-receiver 56 functions as one of the operation determination signal outputters 363, 373, 383, and 393, one of the operation determination signal acquirers 364, 374, 384, and 394, and one of the setting information acquirers 367, 377, 387, 387, and 397. The external storage 53 functions as one of the setting information storages 368, 378, 388, and 398.

Referring back to FIG. 3, in each of the CPUs 310, 320, 330, and 340, the controller 51 implements the functions of the components 363, 364, and 366 to 368, the components 373, 374, and 376 to 378, the components 383, 384, and 386 to 388, or the components 393, 394, and 396 to 398 illustrated in FIG. 7, using the main storage 52, the external storage 53, the operation device 54, and the transmitter-receiver 56 as resources.

For example, the first CPU 310 performs a first operation determination signal output control step as an example output step performed by the first operation determination signal outputter 363. The first CPU 310 also performs a first operation determination signal acquisition step as an example acquisition step performed by the first operation determination signal acquirer 364. The first CPU 310 also performs a first stop selection step as an example selection step and an example stop selection step performed by the first operation stop selector 366. The first CPU 310 also performs a first setting information acquisition step as an example setting information acquisition step performed by the first setting information acquirer 367. The first CPU 310 also performs a first setting information storage step as an example setting information storage step performed by the first setting information storage 368.

For example, the second CPU 320 performs a second operation determination signal output control step as an example output step performed by the second operation determination signal outputter 373. The second CPU 320 also performs a second operation determination signal acquisition step as an example acquisition step performed by the second operation determination signal acquirer 374. The second CPU 320 also performs a second stop selection step as an example selection step and an example stop selection step performed by the second operation stop selector 376. The second CPU 320 also performs a second setting information acquisition step as an example setting information acquisition step performed by the second setting information acquirer 377. The second CPU 320 also performs a second setting information storage step as an example setting information storage step performed by the second setting information storage 378.

For example, the third CPU 330 performs a third operation determination signal output step as an example output step performed by the third operation determination signal outputter 383. The third CPU 330 also performs a third operation determination signal acquisition step as an example acquisition step performed by the third operation determination signal acquirer 384. The third CPU 330 also performs a third stop selection step as an example selection step and an example stop selection step performed by the third operation stop selector 386. The third CPU 330 also performs a third setting information acquisition step as an example setting information acquisition step performed by the third setting information acquirer 387. The third CPU 330 also performs a third setting information storage step as an example setting information storage step performed by the third setting information storage 388.

For example, the fourth CPU 340 performs a fourth operation determination signal output step as an example output step performed by the fourth operation determination signal outputter 393. The fourth CPU 340 also performs a fourth operation determination signal acquisition step as an example acquisition step performed by the fourth operation determination signal acquirer 394. The fourth CPU 340 also performs a fourth stop selection step as an example selection step and an example stop selection step performed by the fourth operation stop selector 396. The fourth CPU 340 also performs a fourth setting information acquisition step as an example setting information acquisition step performed by the fourth setting information acquirer 397. The fourth CPU 340 also performs a fourth setting information storage step as an example setting information storage step performed by the fourth setting information storage 398.

### Hardware Configuration of Engineering Tool 600 in Embodiment 2

Although not illustrated in the figures, the engineering tool 600 includes, similarly to the CPUs 310, 320, 330, and 340, the controller 51, the main storage 52, the external storage 53, the operation device 54, and the transmitter-receiver 56. The engineering tool 600 also includes a display (not illustrated) that displays information input with the operation device 54 and information output by the controller 51. The display includes a display device such as a liquid crystal display (LCD) or an organic electroluminescent (EL) display.

In the engineering tool 600, the controller 51 functions as the setting information generator 610 illustrated in FIG. 7 based on the control program 59. The transmitter-receiver 56 functions as the setting information outputter 620. In the engineering tool 600, the controller 51 implements the functions of the setting information generator 610 and the setting information outputter 620 using, for example, the main storage 52, the external storage 53, the operation device 54, the display, and the transmitter-receiver 56 as resources. The engineering tool 600 performs, for example, the setting information generation step performed by the setting information generator 610 and the setting information output step performed by the setting information outputter 620.

### Details of Functional Configuration of CPUs 310, 320, 330, and 340 According to Embodiment 2

The first resetter 315 performs the reset process to stop the operation of the first CPU 310 when the first voltage drop detector 312 detects a voltage drop in the internal power supply.

The first operation determination signal outputter 363 outputs an operation determination signal to each of the other CPUs 320, 330, and 340 every time a predetermined time elapses.

The first operation determination signal acquirer 364 acquires an operation determination signal output from each of the other CPUs 320, 330, and 340.

The first setting information acquirer 367 acquires the setting information output from the engineering tool 600. The controller 51 in the first CPU 310 stores the acquired setting information into the first setting information storage 368.

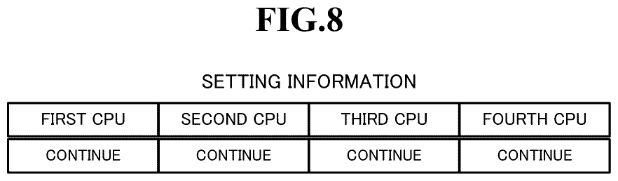

The setting information can identify the operation modes in the PLC 1 set by the user when any of the CPUs 310, 320, 330, and 340 has a failure. The setting information is displayable in, for example, a table illustrated in FIG. 8. The setting information includes the first CPU indicating the CPU 310, the second CPU indicating the CPU 320, the third CPU indicating the CPU 330, and the fourth CPU indicating the CPU 340. For example, as illustrated in FIG. 8, all the above items in the setting information indicating Continue indicate that each of the CPUs 310, 320, 330, and 340 continues operating when any of the other CPUs is determined to have stopped operating. All the above items in the setting information indicating Stop indicate that each of the CPUs 310, 320, 330, and 340 stops operating when any of the other CPUs is determined to have stopped operating.

Referring back to FIG. 7, when determining that any of the other CPUs 320, 330, and 340 has stopped operating based on operation determination signals acquired from the other CPUs 320, 330, and 340, the first operation stop selector 366 selects to stop or not to stop the operation of the first CPU 310 based on the setting information. The first operation stop selector 366 determines that a CPU among the other CPUs 320, 330, and 340 has stopped operating when the CPU does not acquire the operation determination signal for a period longer than a predetermined maximum allowable time.

The first operation stop selector 366 then refers to the setting information stored in the first setting information storage 368 and selects to stop the operation of the first CPU 310 when the first CPU indicates Stop. When the first operation stop selector 366 selects to stop the operation, the first resetter 315 performs the reset process to stop the operation of the first CPU 310. In contrast, the first operation stop selector 366 selects to continue the operation of the first CPU 310 when the first CPU indicates Continue. When the first operation stop selector 366 selects to continue the operation, the first resetter 315 does not perform the reset process, and the first CPU 310 continues operating. In this case, the first CPU 310 performs a fallback operation as an operation for when none of the CPUs 320, 330, and 340 stops operating with an abnormality. The first CPU 310 resumes the normal operation when acquiring an operation determination signal output from the CPU recovered after recovery work by a manager, such as replacement or repair of the CPU that has stopped operating.

The same processes apply to the components 322, 373, 374, 325, and 376 to 378 in the second CPU 320, with the first CPU 310 replaced with the second CPU 320, the first voltage drop detector 312 with the second voltage drop detector 322, the first operation determination signal outputter 363 with the second operation determination signal outputter 373, the first operation determination signal acquirer 364 with the second operation determination signal acquirer 374, the first resetter 315 with the second resetter 325, the first operation stop selector 366 with the second operation stop selector 376, the first setting information acquirer 367 with the second setting information acquirer 377, the first setting information storage 368 with the second setting information storage 378, and the CPUs 320, 330, and 340 with the CPUs 310, 330, and 340. The example with these components is thus not described in detail to avoid redundancy.

The same processes apply to the components 332, 383, 384, 335, and 386 to 388 in the third CPU 330, with the first CPU 310 replaced with the third CPU 330, the first voltage drop detector 312 with the third voltage drop detector 332, the first operation determination signal outputter 363 with the third operation determination signal outputter 383, the first operation determination signal acquirer 364 with the third operation determination signal acquirer 384, the first resetter 315 with the third resetter 335, the first operation stop selector 366 with the first operation stop selector 386, the first setting information acquirer 367 with the third setting information acquirer 387, the first setting information storage 368 with the third setting information storage 388, and the CPUs 320, 330, and 340 with the CPUs 310, 320, and 340. The example with these components is thus not described in detail to avoid redundancy.

The same processes apply to the components 342, 393, 394, 345, and 396 to 398 in the fourth CPU 340, with the first CPU 310 replaced with the fourth CPU 340, the first voltage drop detector 312 with the fourth voltage drop detector 342, the first operation determination signal outputter 363 with the fourth operation determination signal outputter 393, the first operation determination signal acquirer 364 with the fourth operation determination signal acquirer 394, the first resetter 315 with the fourth resetter 345, the first operation stop selector 366 with the fourth operation stop selector 396, the first setting information acquirer 367 with the fourth setting information acquirer 397, the first setting information storage 368 with the fourth setting information storage 398, and the CPUs 320, 330, and 340 with the CPUs 310, 320, and 330. The example with these components is thus not described in detail to avoid redundancy.

### Details of Functional Configuration of Engineering Tool 600 in Embodiment 2

The setting information generator 610 generates the setting information based on information input by the user on a setting screen (not illustrated) using the operation device 54.

When the setting information generator 610 generates the setting information, the setting information outputter 620 outputs the setting information to the PLC 1.

### Flowchart of Stop Selection Process in Embodiment 2

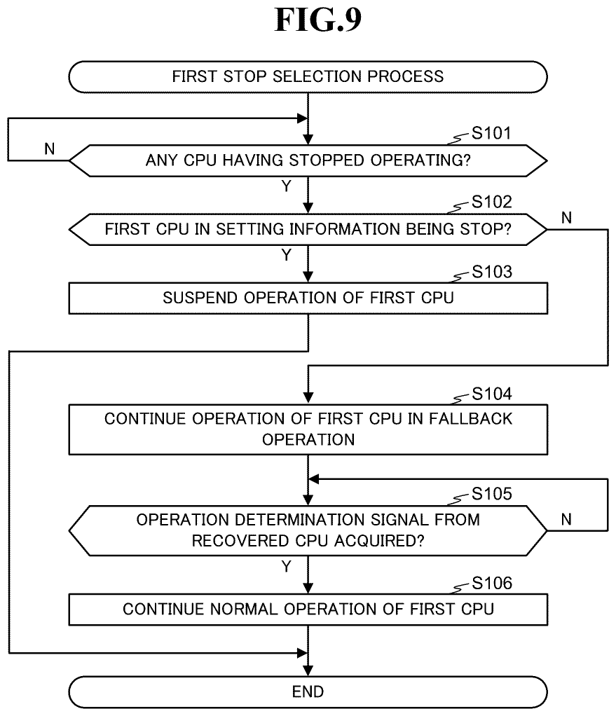

A process in which each of the CPUs 310, 320, 330, and 340 selects to stop or not to stop operating based on the operation determination signal is now described using a flowchart. The CPUs 310, 320, 330, and 340 have the same structure as described above. Thus, a first stop selection process for the first CPU 310 alone is described, and the first stop selection processes for the remaining CPUs 320, 330, and 340 are not described to avoid redundancy. The first CPU 310 starts the normal operation after being powered on and starts the first stop selection process illustrated in FIG. 9.

The first operation stop selector 366 first determines whether any of the other CPUs 320, 330, and 340 does not acquire the operation determination signal for a period longer than the maximum allowable time to determine whether any of the other CPUs 320, 330, and 340 has stopped operating (step S101). When none of the other CPUs 320, 330, and 340 has stopped operating (No in step S101), the first operation stop selector 366 repeats the processing in step S101 until any of the other CPUs 320, 330, and 340 is determined to have stopped operating.

When any of the other CPUs 320, 330, and 340 has stopped operating (Yes in step S101), the first operation stop selector 366 refers to the setting information stored in the first setting information storage 368 to determine whether the first CPU indicates Stop (step S102). When the first CPU indicates Stop (Yes in step S102), the first operation stop selector 366 selects to stop the operation of the first CPU 310. The first resetter 315 then performs the reset process to suspend the operation of the first CPU 310 (step S103) and ends the process. In contrast, when the first CPU does not indicate Stop but indicates Continue (No in step S102), the first operation stop selector 366 selects to continue the operation of the first CPU 310, and the first CPU 310 continues operating in the fallback operation (step S104).

The first CPU 310 determines whether the operation determination signal output from the CPU among the other CPUs 320, 330, and 340 that has recovered after recovery work is acquired (step S105). When the operation determination signal is not acquired from the recovered CPU among the other CPUs 320, 330, and 340 (No in step S105), the first CPU 310 repeats the processing in step S105 until the operation determination signal is acquired. When the operation determination signal is acquired from the recovered CPU among the other CPUs 320, 330, and 340 (Yes in step S105), the first CPU 310 continues the normal operation (step S106) and ends the process.

As described above, in the control system 2 according to the present embodiment, the first resetter 315 in the first CPU 310 performs the reset process to stop the operation of the first CPU 310 when the first voltage drop detector 312 detects a voltage drop in the internal power supply. The first operation determination signal outputter 363 outputs the operation determination signal to each of the other CPUs 320, 330, and 340, and the first operation determination signal acquirer 364 acquires the operation determination signal output from each of the other CPUs 320, 330, and 340.

The first operation stop selector 366 determines whether any of the other CPUs 320, 330, and 340 has stopped operating based on the operation determination signal. When any of the other CPUs 320, 330, and 340 has stopped operating, the first operation stop selector 366 selects to stop or not to stop the operation of the first CPU 310 based on the setting information stored in the first setting information storage 368. When the first operation stop selector 366 selects to stop the operation, the first resetter 315 performs the reset process and stops the operation of the first CPU 310. In contrast, when the first operation stop selector 366 selects to continue the operation, the first resetter 315 does not perform the reset process, and the first CPU 310 continues operating.

The same processes as performed by the components 312, 363, 364, 315, and 366 to 368 in the first CPU 310 apply to the components 322, 373, 374, 325, and 376 to 378 in the CPU 320, the components 332, 383, 384, 335, and 386 to 388 in the CPU 330, and the components 342, 393, 394, 345, and 396 to 398 in the CPU 340.

In this manner, the control system 2 according to the present embodiment stops the operation of the PLC 1 when, for example, all the items in the setting information indicate Stop to stop all the CPUs 310, 320, 330, and 340. In contrast, the control system 2 according to the present embodiment continues the operation of the PLC 1 when, for example, all the items in the setting information indicate Continue and the remaining CPUs with no failure among the CPUs 310, 320, 330, and 340 do not stop operating. Thus, the control system 2 in the present embodiment can perform selection for each of the CPUs 310, 320, 330, and 340 based on the setting information to select between the stop mode and the fallback mode. This allows the control system 2 according to the present embodiment to select to stop or to continue the operation of the entire PLC 1 when an abnormality occurs.

In the control system 2 according to the present embodiment, the setting information generator 610 in the engineering tool 600 generates the setting information based on the information input by the user using the operation device 54, and the setting information outputter 620 outputs the setting information to the PLC 1. The first setting information acquirer 367 in the first CPU 310 acquires the setting information, and the acquired setting information is stored into the first setting information storage 368. The same processes as performed by the components 367 and 368 in the first CPU 310 apply to the components 377 and 378 in the CPU 320, the components 387 and 388 in the CPU 330, and the components 397 and 398 in the CPU 340.

In this manner, the user can preselect, before an abnormality occurs, to operate each of the CPUs 310, 320, 330, and 340 in the stop mode or in the fallback mode using the engineering tool 600.

### MODIFICATIONS

The PLC 1 according to Embodiments 1 and 2 described above includes four CPUs 310, 320, 330, and 340 mounted on the base unit 10. In some embodiments, at least two or more CPUs may be mounted on the base unit 10. For example, two CPUs 310 and 320, or five or more CPUs may be mounted on the base unit 10.

The PLC 1 according to Embodiments 1 and 2 described above includes five input-output units 410 to 450 mounted on the base unit 10. In some embodiments, a different number of input-output units may be mounted on the base unit 10. For example, one input-output unit 450, or six or more CPUs may be mounted on the base unit 10.

The PLC 1 according to Embodiment 1 described above includes the switches 318, 328, 338, and 348 that implement the functions of the respective output selectors 316, 326, 336, and 346. In some embodiments, the components other than the switches 318, 328, 338, and 348 may implement the functions of the output selectors 316, 326, 336, and 346. For example, the output selectors 316, 326, 336, and 346 may be implemented by the controller 51 performing control. More specifically, each of the output selectors 316, 326, 336, and 346 may select to output or not to output the reset signal to the other CPUs among the CPUs 320, 330, and 340 based on the setting information acquired from the engineering tool 600. In this case, each of the reset signal output controllers 313, 323, 333, and 343 is to output the reset signal to the CPU with a failure among the CPUs 310, 320, 330, and 340 through the internal circuit and to output the reset signal to all the CPUs 310, 320, 330, and 340 through the base unit 10.

The control system 2 according to Embodiment 2 described above includes the operation stop selectors 366, 376, 386, and 396 that select the CPU 310 to stop or not to stop operating based on the setting information generated and output by the engineering tool 600. In some embodiments, the setting information may not be generated and output by the engineering tool 600. For example, the CPUs 310, 320, 330, and 340 may each include a switch on the exterior to generate the setting information indicating the suspension or continuation of the respective CPUs 310, 320, 330, and 340 based on the on- or off-status of the switch operated by the user.

As in Embodiments 1 and 2 described above, the PLC 1 may select between the stop mode and the fallback mode for each of the CPUs 310, 320, 330, and 340. In some embodiments, the PLC 1 may have a different selection. For example, the PLC 1 may select between the stop mode and the fallback mode for all the CPUs 310, 320, 330, and 340. In this case, for example, the switches 318, 328, 338, and 348 being single-pole double-throw switches in Embodiment 1 described above may be replaced with a four-pole double-throw switch on the exterior of the base unit 10 to select between stopping and continuing all the CPUs 310, 320, 330, and 340 based on the on- or off-status of the switch operated by the user. In this case, the engineering tool 600 in Embodiment 2 described above may allow the user to select between the stop mode and the fallback mode for all the CPUs 310, 320, 330, and 340.

The CPUs 310, 320, 330, and 340 each including, for example, the controller 51, the main storage 52, the external storage 53, the operation device 54, the transmitter-receiver 56, and the internal bus 50 to perform processes may be mainly implemented by, for example, a program for performing the above operations stored in a non-transitory recording medium such as a flash memory readable by the CPUs 310, 320, 330, and 340, and being distributed and installed on the CPUs 310, 320, 330, and 340. The program may be stored in a storage device included in a server device on a communication network such as a local area network (LAN) or the Internet, and may be downloaded by each of the CPUs 310, 320, 330, and 340 to provide a computer.

When the functions of each of the CPUs 310, 320, 330, and 340 are implementable partially by the operating system (OS) or through cooperation between the OS and an application program, the application program may be stored alone in a non-transitory recording medium or a storage device.

The program may also be superimposed on a carrier wave to be provided through a communication network. For example, the program may be posted on a bulletin board system (BBS) on the communication network to be distributed through the network. The above processes may be performed by launching the program and executing the program under control by the OS in the same manner as in another application program.

The foregoing describes some example embodiments for explanatory requests. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### Reference Signs List

1 PLC
2 Control system
10 Base unit
20 Power supply unit
30 CPU
40 I/O unit
50 Internal bus
51 Controller
52 Main storage
53 External storage
54 Operation device
56 Transmitter-receiver
59 Control program
310 First CPU
311 First input-output controller
312 First voltage drop detector
313 First reset signal output controller
314 First reset signal acquirer
315 First resetter
316 First output selector
317 First power supply monitoring IC
318 First switch
320 Second CPU
321 Second input-output controller
322 Second voltage drop detector
323 Second reset signal output controller
324 Second reset signal acquirer
325 Second resetter
326 Second output selector
327 Second power supply monitoring IC
328 Second switch
330 Third CPU
331 Third input-output controller
332 Third voltage drop detector
333 Third reset signal output controller
334 Third reset signal acquirer
335 Third resetter
336 Third output selector
337 Third power supply monitoring IC
338 Third switch
340 Fourth CPU
341 Fourth input-output controller
342 Fourth voltage drop detector
343 Fourth reset signal output controller
344 Fourth reset signal acquirer
345 Fourth resetter
346 Fourth output selector
347 First power supply monitoring IC
348 First switch
363 First operation determination signal outputter
364 First operation determination signal acquirer
366 First operation stop selector
367 First setting information acquirer
368 First setting information storage
373 Second operation determination signal outputter
374 Second operation determination signal acquirer
376 Second operation stop selector
377 Second setting information acquirer
378 Second setting information storage
383 Third operation determination signal outputter
384 Third operation determination signal acquirer
386 Third operation stop selector
387 Third setting information acquirer
388 Third setting information storage
393 Fourth operation determination signal outputter
394 Fourth operation determination signal acquirer
396 Fourth operation stop selector
397 Fourth setting information acquirer
398 Fourth setting information storage
410 First input-output unit
420 Second input-output unit
430 Third input-output unit
440 Fourth input-output unit
450 Fifth input-output unit
500 Communication line
501 First communication line
502 First diode
503 Second communication line
504 Zener diode
505 Third communication line
506 Transistor
507 Fourth communication line
508 Fifth communication line
509, 520 First contact
510 Second diode
511 Sixth communication line
512 First terminal
513 Seventh communication line
514, 525 Second contact
515 Second terminal
516 Eighth communication line
517 Third terminal
518, 523, 528, 533, 535 Contact
519 Ninth communication line
521 First pull-up resistor
522 Tenth signal line
524 Eleventh signal line
526 Second pull-up resistor
527 Twelfth signal line
529 Thirteenth signal line
530 Third contact
531 Third pull-up resistor
532 Fourteenth signal line
534 Fifteenth signal line
536 Fourth pull-up resistor
537 Sixteenth signal line
600 Engineering tool
610 Setting information generator
620 Setting information outputter
700 Internet

1. A programmable logic controller including a first central processing unit and a second central processing unit capable of controlling a control target device independently of each other, the programmable logic controller comprising:
processing circuitry; and
a transmitter-receiver, wherein
the first central processing unit includes an outputter to output, to the second central processing unit, an operation determination signal for determining that the first central processing unit is in operation when a voltage drop in an internal power supply in the first central processing unit is not detected, and
the processing circuitry
selects to stop or not to stop an operation of the second central processing unit when the second central processing unit does not acquire the operation determination signal, and
stops the operation of the second central processing unit when the processing circuitry selects to stop the operation of the second central processing unit, and does not stop the operation of the second central processing unit when the processing circuitry selects not to stop the operation of the second central processing unit.

2. The programmable logic controller according to claim 1, wherein
the processing circuitry
selects to output or not to output, from the first central processing unit to the second central processing unit, an operation stop signal for stopping the operation of the second central processing unit when the voltage drop of the internal power supply in the first central processing unit is detected, and
causes the first central processing unit to output the operation stop signal when the processing circuitry selects to output the operation stop signal, and causes the first central processing unit not to output the operation stop signal when the processing circuitry selects not to output the operation stop signal.

3.-6. (canceled)

7. A central processing unit capable of controlling a control target device independently of another central processing unit mounted on a programmable logic controller, the central processing unit comprising:
processing circuitry; and
a transmitter-receiver, wherein
the processing circuitry
selects to stop or not to stop an operation of the central processing unit when an operation determination signal for determining that the another central processing unit is in operation is not acquired from the another central processing unit; and
stops the operation of the central processing unit when the operation determination signal is not acquired from the another central processing unit and the processing circuitry selects to stop the operation of the central processing unit, and does not stop the operation of the central processing unit when the operation determination signal is not acquired from the another central processing unit and the processing circuitry selects not to stop the operation of the central processing unit.

8. (canceled)

9. A non-transitory computer-readable recording medium storing a program, the program causing a programmable logic controller including a first central processing unit and a second central processing unit mounted on the programmable logic controller to execute processing comprising:
selecting to stop or not to stop an operation of the second central processing unit when an operation determination signal for determining that the first central processing unit is in operation is not acquired from the first central processing unit; and
controlling the second central processing unit to stop operating when to stop the operation of the second central processing unit is selected, and controlling the second central processing unit not to stop operating when not to stop the operation of the second central processing unit is selected.
